(19) United States
(12) Patent Application Publication
(10) Pub. No.: US 2007/0237131 A1
(43) Pub. Date: Oct. 11, 2007

(54) Voip client information

(75) Inventors: David Milstein, Redmond, WA (US); David Howell, Seattle, WA (US); Kuansan Wang, Bellevue, WA (US); Linda Criddle, Kirkland, WA (US); Michael D. Malueg, Renton, WA (US); Lon-Chan Chu, Redmond, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: Microsoft Corporation, Redmond, WA (US)

(21) Appl. No.: 11/401,064

(22) Filed: Apr. 10, 2006

(51) Int. Cl. H04L 12/66

(52) U.S. Cl. 370/352

(57) ABSTRACT

A method and system for collecting and providing required information to a VoIP client or other service providers is provided. The inquiry for information will be received and processed to identify appropriate contextual information which will be transmitted to the information inquiring party. For example, an inquiry for location information of the VoIP client may be received and the contextual information relating to the location of the VoIP client is collected and provided. Upon identifying the appropriate contextual information, a source suitable for providing the appropriate contextual information is determined. By utilizing various paths, the appropriate contextual information is obtained from the source. The obtained appropriate contextual information is provided to the VoIP client.

### BACKGROUND

Generally described, an Internet telephony system provides an opportunity for users to have a call connection with enhanced calling features compared to a conventional Public Switched Telephone Network (PSTN)-based telephony system. In a typical Internet telephony system, often referred to as Voice over Internet Protocol (VoIP), audio information is processed into a sequence of data blocks, called packets, for communications utilizing an Internet Protocol (IP) data network. During a VoIP call conversation, the digitized voice is converted into small frames of voice data and a voice data packet is assembled by adding an IP header to the frame of voice data that is transmitted and received.

VoIP technology has been favored because of its flexibility and portability of communications, ability to establish and control multimedia communication, and the like. VoIP technology will likely continue to gain favor because of its ability to provide enhanced calling features and advanced services which the traditional telephony technology has not been able to provide. However, current VoIP approaches may not provide a way for inquiring contextual information related to location or obtaining such contextual information over a VoIP conversation.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A method and system for collecting and providing required information to a VoIP client or other service providers is provided. The inquiry for information will be received and processed to identify appropriate contextual information which will be transmitted to the information inquiring party. For example, an inquiry for location information of the VoIP client may be received and the contextual information relating to the location of the VoIP client is collected and provided. Upon identifying the appropriate contextual information, a source suitable for providing the appropriate contextual information is determined. By utilizing various paths, the appropriate contextual information is obtained from the source. The obtained appropriate contextual information is provided to the VoIP client.

In accordance with an aspect of the present invention, a method for providing contextual information relating to an information inquiry over a communication channel between a calling client and a called client is provided. An inquiry for information relating to the called client may be received. Upon receipt of the inquiry, the contextual information relating to the called client may be obtained. Based on the called client's contextual information, a set of information corresponding to the inquiry may be identified and obtained from third party service provider, the called client, or local storage of the service provider. The obtained set of information may be provided back to the calling client.

In accordance with another aspect of the present invention, a computer-readable medium having computer-executable components for providing information in response to an inquiry over a VoIP communication channel is provided. The computer-executable components include an information managing component for receiving an inquiry for information, an information processing component for processing the first client's contextual information and identifying a source for obtaining the information. The information managing component obtains information corresponding to the inquiry from the source and provides the obtained information to the second client. The information processing component identifies a plurality of sources and selects the most appropriate source based on the contextual information. The information managing component transmits predetermined default information if the information processing component cannot identify any source. The information processing component updates the contextual information by adding the obtained information; and wherein the information managing component transmits the updated contextual information.

In accordance with yet another aspect of the present invention, a method for providing contextual information relating to a location over a communication channel between a first client and a second, the method comprising: an inquiry for location information of the first client may be received. The inquiry for information is received as part of contextual information received from the second client. The contextual information is related to a conversation over a VoIP communication channel between the first client and the second client.

Upon receipt of the inquiry, a set of contextual information relating to the first client may be obtained. It is determined as to whether the location information is available from the set of obtained contextual information. If the location information is available, the location information will be provided to the second client. In one embodiment, a type of the location information, such as a geographic location of the first client, an IP address of a device of the first client and the like, may be identified based on the contextual information received from the second client. If the location information is not available, at least one source for obtaining the location information may be determined based on the set of obtained contextual information and then the location information may be obtained from the at least one source.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram illustrative of a VoIP environment for establishing a conversation channel between various clients in accordance with an aspect of the present invention;

FIG. 2 is a block diagram illustrative of a VoIP client in accordance with an aspect of the present invention;

FIG. 3 is a block diagram illustrative of various components associated with a VoIP device in accordance with an aspect of the present invention;

FIG. 4 is a block diagram illustrative of the exchange of data between two VoIP clients over a conversation channel in accordance with an aspect of the present invention;

FIG. 5 is a block diagram of a data packet used over a communication channel established in the VoIP environment of FIG. 1;

FIG. 6 is a block diagram illustrating interactions between two VoIP clients for transferring contextual information defined by identified structured hierarchies in accordance with an aspect of the present invention;

FIGS. 7A and 7B are block diagrams illustrating interactions between VoIP entities for collecting and providing contextual information in response to an inquiry in accordance with an aspect of the present invention;

FIGS. 8-12B are block diagrams illustrative of various attributes and classes of structured hierarchies corresponding to VoIP contextual information in accordance with an aspect of the present invention; and

FIG. 13 is a flow diagram illustrating a location information routine in accordance with an aspect of the present invention.

### DETAILED DESCRIPTION

Generally described, the present invention relates to a method and system for collecting and providing inquired information to a VoIP client or other service providers over a communication channel. More specifically, the present invention relates to a method and system for identifying contextual information, in response to an inquiry for information, collecting and providing the identified contextual information represented according to “structured hierarchies”. “Structured hierarchies,” as used herein, are predefined organizational structures for arranging contextual information to be exchanged between two or more VoIP devices. For example, structured hierarchies may be XML namespaces. Further, a VoIP conversation is a data stream of information related to a conversation, such as contextual information and voice information, exchanged over a conversation channel. When the contextual information is exchanged, any authorized sending party of the contextual information can change the scope, content, or amount of the contextual information that is transmitted to a next receiving party in a determined communication channel path. Although the present invention will be described with relation to illustrative structured hierarchies and an IP telephony environment, one skilled in the relevant art will appreciate that the disclosed embodiments are illustrative in nature and should not be construed as limiting.

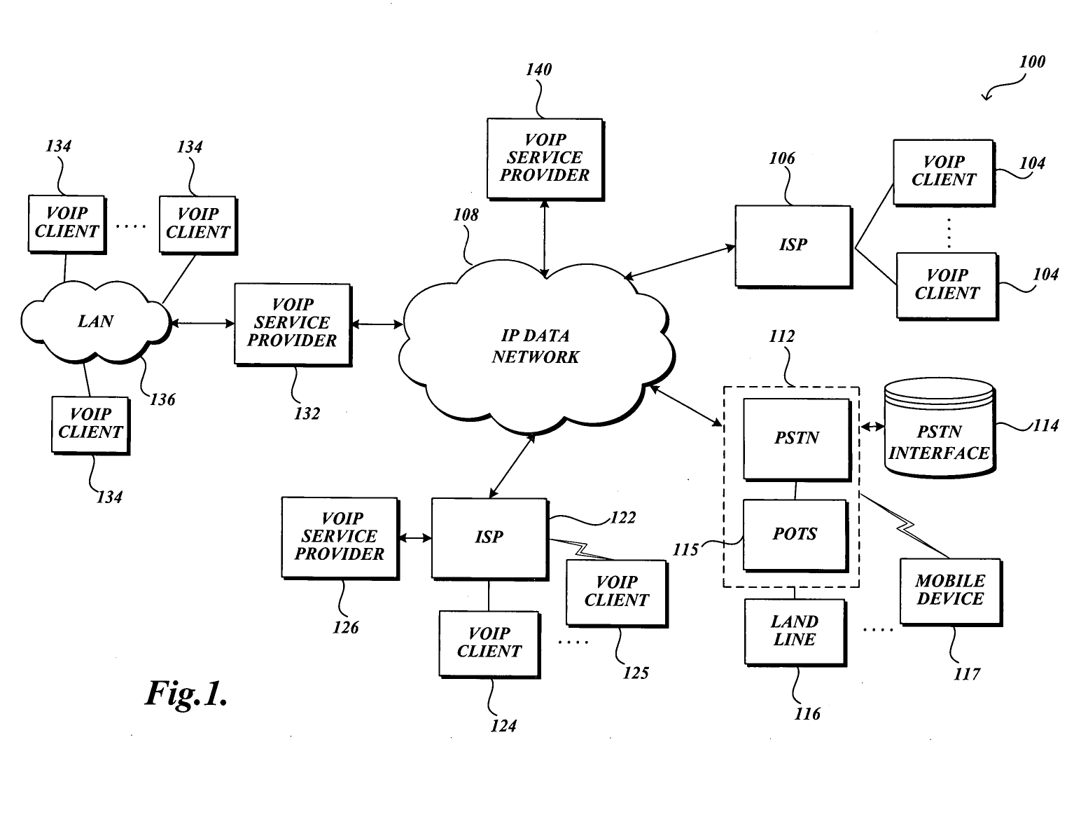

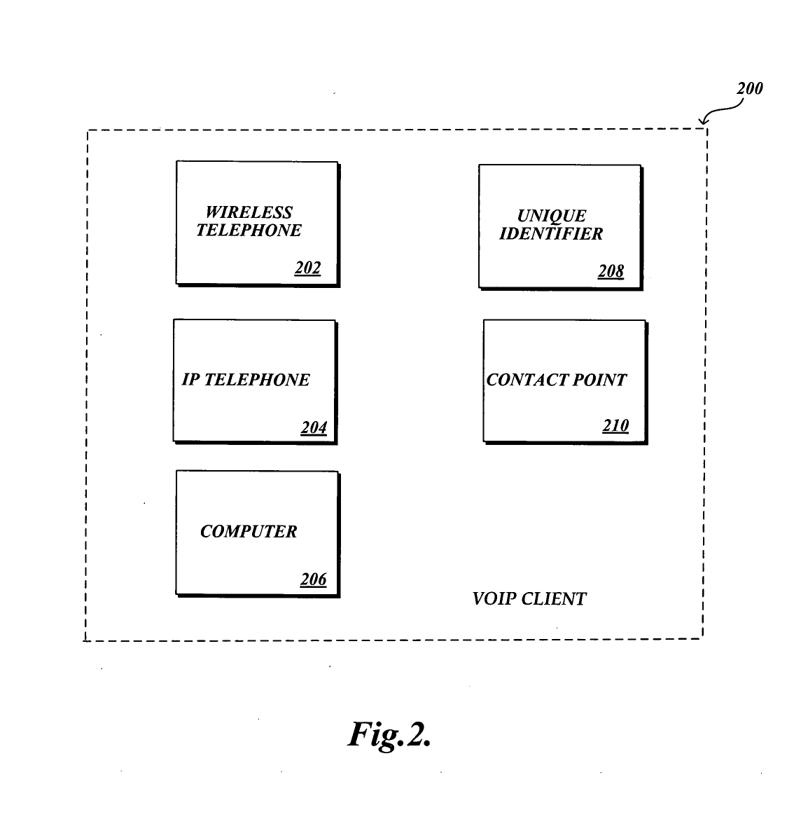

With reference to FIG. 1, a block diagram of an IP telephony environment 100 for providing IP telephone services between various “VoIP clients” is shown. A “VoIP client,” as used herein, refers to a particular contact point, such as an individual, an organization, a company, etc., one or more associated VoIP devices and a unique VoIP client identifier. For example, a single individual, five associated VoIP devices and a unique VoIP client identifier collectively make up a VoIP client. Similarly, a company including five hundred individuals and over one thousand associated VoIP devices may also be collectively referred to as a VoIP client and that VoIP client may be identified by a unique VoIP client identifier. Moreover, VoIP devices may be associated with multiple VoIP clients. For example, a computer (a VoIP device) located in a residence in which three different individuals live, each individual associated with separate VoIP clients, may be associated with each of the three VoIP clients. Regardless of the combination of devices, the unique VoIP client identifier may be used within a voice system to reach the contact point of the VoIP client.

Generally described, the IP telephony environment 100 may include an IP data network 108 such as the Internet, an intranet network, a wide area network (WAN), a local area network (LAN) and the like. The IP telephony environment 100 may further include VoIP service providers 126, 132 providing VoIP services to VoIP clients 124, 125, 134. A VoIP call conversation may be exchanged as a stream of data packets corresponding to voice information, media information, and/or contextual information. As will be discussed in greater detail below, the contextual information includes metadata (information of information) relating to the VoIP conversation, the devices being used in the conversation, the contact point of the connected VoIP clients, and/or individuals that are identified by the contact point (e.g., employees of a company).

The IP telephony environment 100 may also include third party VoIP service providers 140. The VoIP service providers 126, 132, 140 may provide various calling features, such as incoming call-filtering, text data, voice and media data integration, and the integrated data transmission as part of a VoIP call conversation.

VoIP service providers 132 may be coupled to a private network such as a company LAN 136, providing IP telephone services (e.g., internal calls within the private network, external calls outside of the private network, and the like) and multimedia data services to several VoIP clients 134 communicatively connected to the company LAN 136. Similarly, VoIP service providers, such as VoIP service provider 126, may be coupled to Internet Service Provider (ISP) 122, providing IP telephone services and VoIP services for clients of the ISP 122.

In one embodiment, one or more ISPs 106, 122 may be configured to provide Internet access to VoIP clients 104, 124, 125 so that the VoIP clients 104, 124, 125 can maintain conversation channels established over the Internet. The VoIP clients 104, 124, 125 connected to the ISP 106, 122 may use wired and/or wireless communication lines. Further, each VoIP client 104, 124, 125, 134 can communicate with Plain Old Telephone Service (POTS) 115 communicatively connected to a PSTN 112. A PSTN interface 114 such as a PSTN gateway may provide access between PSTN and the IP data network 108. The PSTN interface 114 may translate VoIP data packets into circuit switched voice traffic for PSTN and vice versa. The PSTN 112 may include a land line device 116, a mobile device 117, and the like.

Conventional voice devices, such as land line 116, may request a connection with the VoIP client based on the unique identifier of that client and the appropriate VoIP device associated with the VoIP client will be used to establish a connection. In one example, an individual associated with the VoIP client may specify which devices are to be used in connecting a call based on a variety of conditions (e.g., connection based on the calling party, the time of day, etc.).

It is understood that the above-mentioned configuration in the environment 100 is merely exemplary. It will be appreciated by one of ordinary skill in the art that any suitable configurations with various VoIP entities can be part of the environment 100. For example, VoIP clients 134 coupled to LAN 136 may be able to communicate with other VoIP clients 104, 124, 125, 134 with or without VoIP service providers 132 or ISP 106, 122. Further, an ISP 106, 122 can also provide VoIP services to its client.

Referring now to FIG. 2, a block diagram illustrating an exemplary VoIP client 200 that includes several VoIP devices and a unique client identifier, in accordance with an embodiment of the present invention, is shown. Each VoIP device 202, 204, 206 may include a storage that is used to maintain voice messages, address books, client specified rules, priority information related to incoming calls, etc. Alternatively, or in addition thereto, a separate storage, maintained for example by a service provider, may be associated with the VoIP client and accessible by each VoIP device that contains information relating to the VoIP client. In an embodiment, any suitable VoIP device such as a wireless phone 202, an IP phone 204, or a computer 206 with proper VoIP applications may be part of the VoIP client 200. The VoIP client 200 also maintains one or more unique client identifiers 208. The unique client identifier(s) 208 may be constant or change over time. For example, the unique identifier(s) 208 may change with each call. The unique client identifier is used to identify the client and to connect with the contact point 210 associated with the VoIP client. The unique client identifier may be maintained on each VoIP device included in the VoIP client and/or maintained by a service provider that includes an association with each VoIP device included in the VoIP client. In the instance in which the unique client identifier is maintained by a service provider, the service provider may include information about each associated VoIP device and knowledge as to which device(s) to connect for incoming communications. In an alternative embodiment, the VoIP client 200 may maintain multiple client identifiers. In this embodiment, a unique client identifier may be temporarily assigned to the VoIP client 200 for each call session.

The unique client identifier may be used similar to a telephone number in PSTN. However, instead of dialing a typical telephone number to ring a specific PSTN device, such as a home phone, the unique client identifier is used to reach a contact point, such as an individual or company, which is associated with the VoIP client. Based on the arrangement of the client, the appropriate device(s) will be connected to reach the contact point. In one embodiment, each VoIP device included in the VoIP client may also have its own physical address in the network or a unique device number. For example, if an individual makes a phone call to a POTS client using a personal computer (VoIP device), the VoIP client identification number in conjunction with an IP address of the personal computer will eventually be converted into a telephone number recognizable in PSTN.

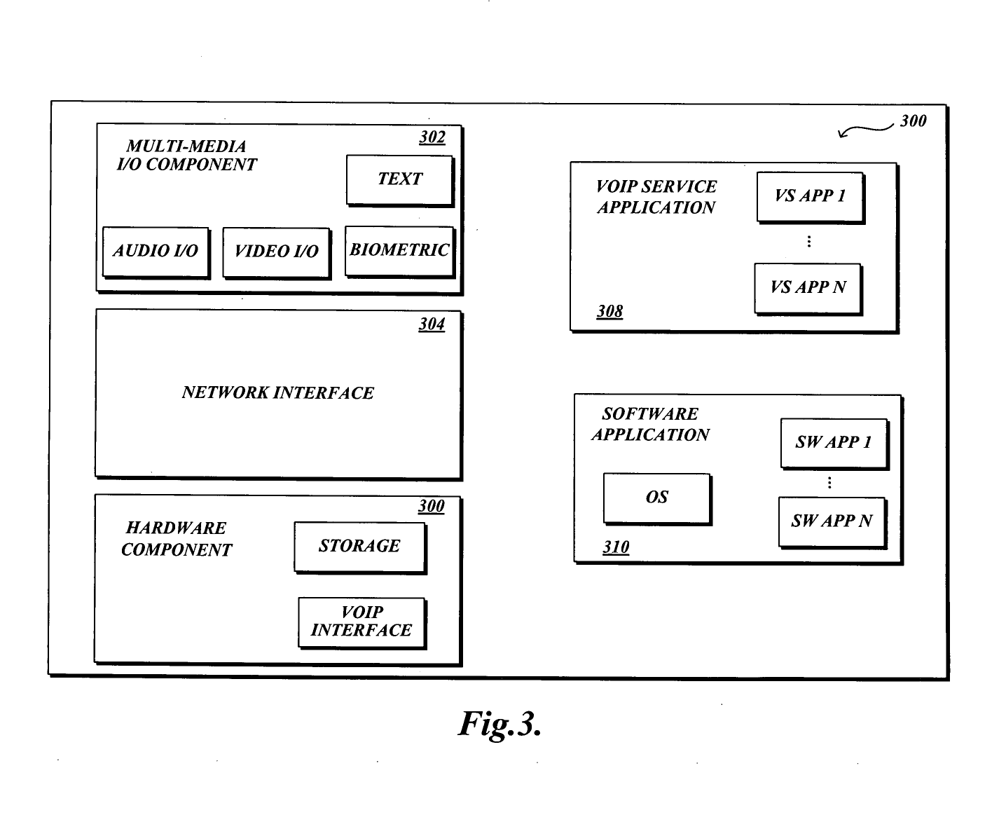

FIG. 3 is a block diagram of a VoIP device 300 that may be associated with one or more VoIP clients and used with embodiments of the present invention. It is to be noted that the VoIP device 300 is described as an example. It will be appreciated that any suitable device with various other components can be used with embodiments of the present invention. For utilizing VoIP services, the VoIP device 300 may include components suitable for receiving, transmitting and processing various types of data packets. For example, the VoIP device 300 may include a multimedia input/output component 302 and a network interface component 304. The multimedia input/output component 302 may be configured to input and/or output multimedia data (including audio, video, and the like), user biometrics, text, application file data, etc. The multimedia input/output component 302 may include any suitable user input/output components such as a microphone, a video camera, a display screen, a keyboard, user biometric recognition devices and the like. The multimedia input/output component 302 may also receive and transmit multimedia data via the network interface component 304. The network interface component 304 may support interfaces such as Ethernet interfaces, frame relay interfaces, cable interfaces, DSL interfaces, token ring interfaces, radio frequency (air interfaces), and the like. The VoIP device 300 may comprise a hardware component 306 including permanent and/or removable storage such as read-only memory devices (ROM), random access memory (RAM), hard drives, optical drives, and the like. The storage may be configured to store program instructions for controlling the operation of an operating system and/or one or more applications and to store contextual information related to individuals (e.g., voice profiles, user biometrics information, etc.) associated with the VoIP client in which the device is included. In one embodiment, the hardware component 306 may include a VoIP interface card which allows a non-VoIP device to transmit and receive a VoIP conversation.

The device 300 may further include a software application component 310 for the operation of the device 300 and a VoIP Service application component 308 for supporting various VoIP services. The VoIP service application component 308 may include applications such as data packet assembler/disassembler applications, a structured hierarchy parsing application, audio Coder/Decoder (CODEC), video CODEC and other suitable applications for providing VoIP services.

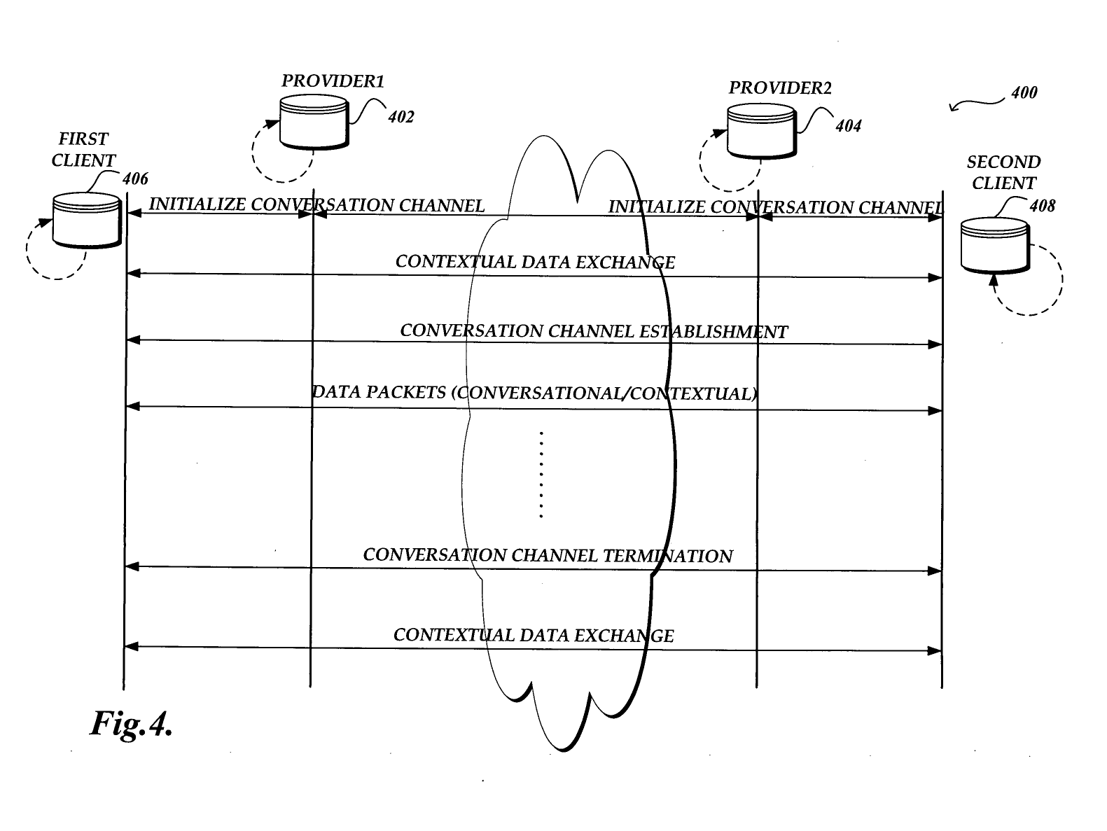

With reference to FIG. 4, a block diagram illustrative of a conversation flow 400 between VoIP devices of two different VoIP clients over a conversation channel, in accordance with an embodiment of the present invention, is shown. During a connection set-up phase, a VoIP device of a first VoIP client 406 requests to initiate a conversation channel with a second VoIP client 408. In an illustrative embodiment, a VoIP service provider 402 (Provider 1) for the first VoIP client 406 receives the request to initiate a conversation channel and forwards the request to a VoIP service provider 404 (Provider 2) for the second VoIP client 406. While this example utilizes two VoIP service providers and two VoIP clients, any number and combination of VoIP clients and/or service providers may be used with embodiments of the present invention. For example, only one service provider may be utilized in establishing the connection. In yet another example, communication between VoIP devices may be direct, utilizing public and private lines, thereby eliminating the need for a VoIP service provider. In a peer to peer context, communication between VoIP devices may also be direct without having any service providers involved.

There are a variety of protocols that may be selected for use in exchanging information between VoIP clients, VoIP devices, and/or VoIP service providers. For example, when Session Initiation Protocol (SIP) is selected for a signaling protocol, session control information and messages will be exchanged over a SIP signaling path/channel and media streams will be exchanged over Real-Time Transport Protocol (RTP) path/channel. For the purpose of discussion, a communication channel, as used herein, generally refers to any type of data or signal exchange path/channel. Thus, it will be appreciated that depending on the protocol, a connection set-up phase and a connection termination phase may require additional steps in the conversation flow 400.

For ease of explanation, we will utilize the example in which, the first VoIP client 406 and the second VoIP client 408, each includes only one VoIP device. Accordingly, the discussion provided herein will refer to connection of the two VoIP devices. The individual using the device of the first VoIP client 406 may select or enter the unique client identifier of the client that is to be called. Provider 1 402 receives the request from the device of the first VoIP client 408 and determines a terminating service provider (e.g., Provider 2 404 of the second VoIP client 408) based on the unique client identifier included in the request. The request is then forwarded to Provider 2 404. This call initiation will be forwarded to the device of the second VoIP client. A conversation channel between the device of the first VoIP client 406 and a device of the second VoIP client 408 can then be established.

In an illustrative embodiment, before the devices of the first VoIP client 406 and the second VoIP client 408 begin to exchange data packets, contextual information may be exchanged. As will be discussed in a greater detail below, the contextual information may be packetized in accordance with a predefined structure that is associated with the conversation. Any device associated with the first VoIP client 406, the service provider of the first VoIP client 406, or a different device/service provider may determine the structure based on the content of the contextual information. In one embodiment, the exchanged contextual information may include information relating to the calling VoIP client 406, the device, and the VoIP client 408 being called. Further, an inquiry for particular information may be transmitted as part of the contextual information. For example, the VoIP client 406 may send an inquiry for geographic location information of the VoIP client 408. Provider 1 402, or the called VoIP client may collect the geographic location information of the called VoIP client and provide the collected information to the calling VoIP client 406. In one embodiment, Provider 1 402 may already have the geographic location information of the client when the client requests a call initiation. Alternatively, Provider 1 402 may obtain such information from a location service server maintaining the VoIP clients' location information.

Available media types, rules of the calling client and the client being called, and the like, may also be part of the contextual information that is exchanged during the connection set-up phase. The contextual information may be processed and collected by one of the devices of the first VoIP client 406, one of the devices of the second VoIP client 408, and/or by the VoIP service providers (e.g., Provider 1 402 and Provider 2 404), depending on the nature of the contextual information. In one embodiment, the VoIP service providers 402, 404 may add, delete and/or modify some information to/from the client's contextual information before forwarding the contextual information.

In response to a request to initiate a conversation channel, the second VoIP client 408 may accept the request for establishing a conversation channel or execute other appropriate actions such as rejecting the request via Provider 2 404. The appropriate actions may be determined based on the obtained contextual information. When a conversation channel is established, a device of the first VoIP client 406 and a device of the second VoIP client 408 start communicating with each other by exchanging data packets. As will be described in greater detail below, the data packets, including conversation data packets and contextual data packets, are communicated over the established conversation channel between the connected devices.

Conversation data packets carry data related to a conversation, for example, a voice data packet, or multimedia data packet. Contextual data packets carry information relating to data other than the conversation data. Once the conversation channel is established, either the first VoIP client 406 or the second VoIP client 408 can request to terminate the conversation channel. Some contextual information may be exchanged between the first VoIP client 406 and the second VoIP client 408 after the termination.

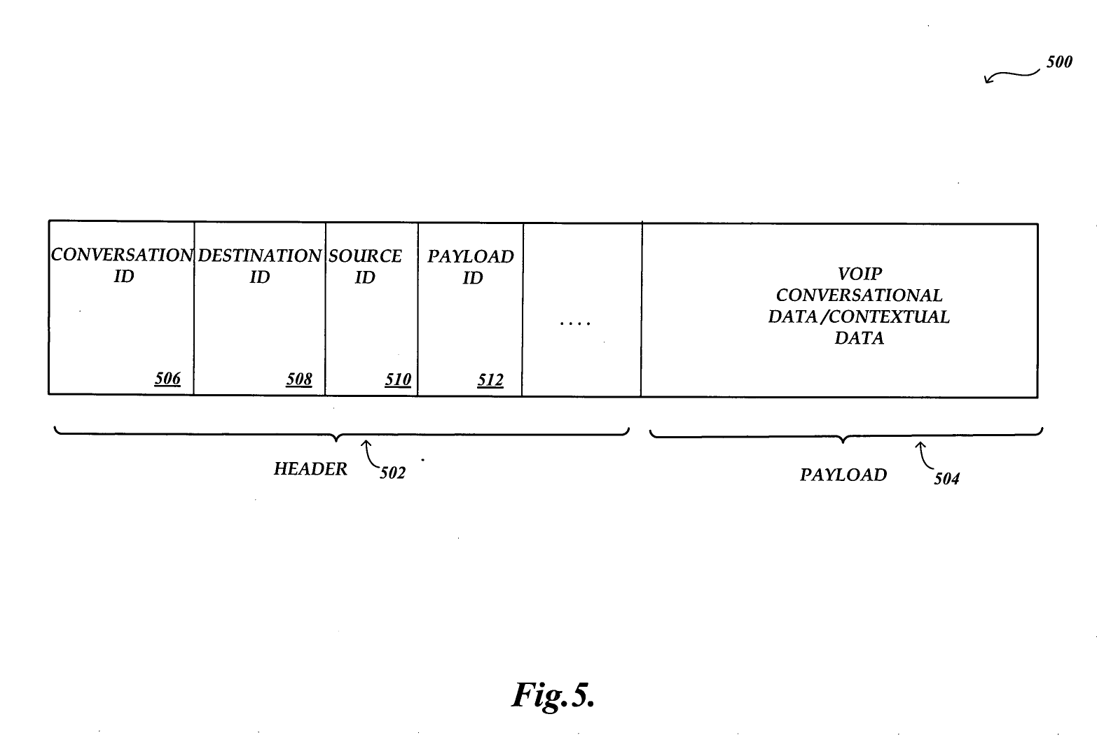

FIG. 5 is a block diagram of a data packet structure 500 used over a communication (conversation) channel in accordance with an embodiment of the present invention. The data packet structure 500 may be a data packet structure for an IP data packet suitable for being utilized to carry conversation data (e.g., voice, multimedia data, and the like) or contextual data (e.g., information relating to the VoIP services, and the like). However, any other suitable data structure can be utilized to carry conversation data or contextual data. The data packet structure 500 includes a header 502 and a payload 504. The header 502 may contain information necessary to deliver the corresponding data packet to a destination. Additionally, the header 502 may include information utilized in the process of a conversation. Such information may include conversation ID 506 for identifying a conversation (e.g., call), a Destination ID 508, such as a unique client identifier of the client being called, a Source ID 510 (unique client identifier of the calling client or device identifier), Payload ID 512 for identifying the type of payload (e.g., conversation or contextual), individual ID (not shown) for identifying the individual to which the conversation data is related, and the like. In an alternative embodiment, the header 502 may contain information regarding Internet protocol versions and payload length, among others. The payload 504 may include conversational or contextual data relating to an identified conversation. As will be appreciated by one of ordinary skill in the art, additional headers may be used for upper layer headers such as a TCP header, a UDP header, and the like.

In one embodiment of the present invention, a structured hierarchy may be predefined for communicating contextual information over a VoIP conversation channel. The contextual information may include any information relating to VoIP clients, VoIP devices, conversation channel connections (e.g., call basics), conversation context (e.g., call context) and the like. More specifically, the contextual information may include client preference, client rules, client's location (e.g., user location, device location, etc.), biometrics information, the user's confidential information, VoIP device functionality, VoIP service providers information, media type, media parameters, calling number priority, keywords, information relating to application files, and the like. The contextual information may be processed and collected at each VoIP client and/or the VoIP service providers depending on the nature of the contextual data. In one aspect, the VoIP service providers may add, modify and/or delete the VoIP client's contextual data before forwarding the contextual information. For example, the VoIP client's confidential information will be deleted by the VoIP service provider associated with that client unless the client authorizes such information to be transmitted. In some cases, a minimal amount of contextual information is transmitted outside of an intranet network.

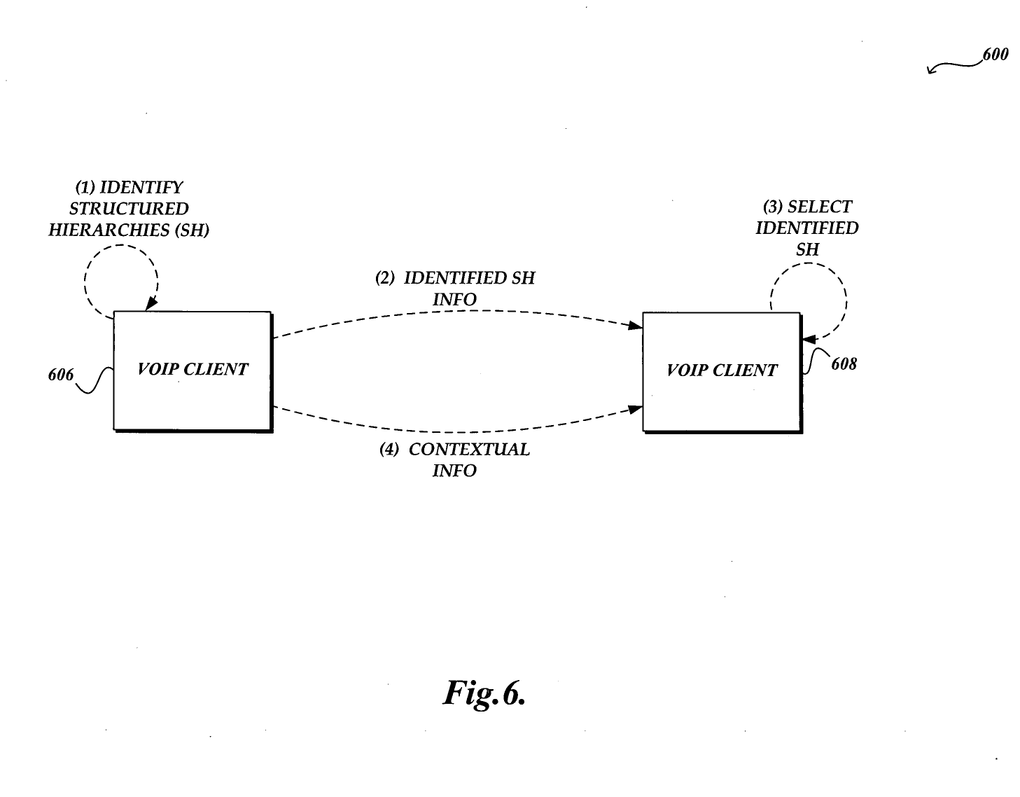

With reference to FIG. 6, a block diagram 600 illustrating interactions between two VoIP clients for transferring contextual information, in accordance with an embodiment of the present invention, is shown. As with FIG. 4, the example described herein will utilize the scenario in which each client only has one device associated therewith and the connection occurs between those two devices. In one embodiment, devices of VoIP Client 606 and VoIP Client 608 have established a VoIP conversation channel. It may be identified which structured hierarchies will be used to carry certain contextual information by VoIP Client 606. The information regarding the identified structured hierarchies may include information about which structured hierarchies are used to carry the contextual information, how to identify the structured hierarchy, and the like. Such information will be exchanged between VoIP Client 606 and VoIP Client 608 before the corresponding contextual information is exchanged. Upon receipt of the information identifying which structured hierarchy will be used to carry the contextual information, VoIP Client 608 looks up predefined structured hierarchies (e.g., XML namespace and the like) to select the identified structured hierarchies. In one embodiment, the predefined structured hierarchies can be globally stored and managed in a centralized location accessible from a group of VoIP clients. In this embodiment, a Uniform Resource Identifier (URI) address of the centralized location may be transmitted from VoIP Client 606 to VoIP Client 608.

In another embodiment, each VoIP client may have a set of predefined structured hierarchies stored in a local storage of any devices or a dedicated local storage which all devices can share. The predefined structured hierarchies may be declared and agreed upon between VoIP clients before contextual information is exchanged. In this manner, the need to provide the structure of the contextual data packets may be eliminated and thus the amount of transmitted data packets corresponding to the contextual data is reduced. Further, by employing the predefined structured hierarchies, data packets can be transmitted in a manner which is independent of hardware and/or software.

Upon retrieving the identified structured hierarchy, VoIP Client 608 is expecting to receive a data stream such that data packets corresponding to the data stream are defined according to the identified structured hierarchies. VoIP Client 606 can begin sending contextual information represented in accordance with the identified structured hierarchies. In one embodiment, VoIP Client 608 starts a data binding process with respect to the contextual information. For example, instances of the identified structured hierarchies may be constructed with the received contextual information.

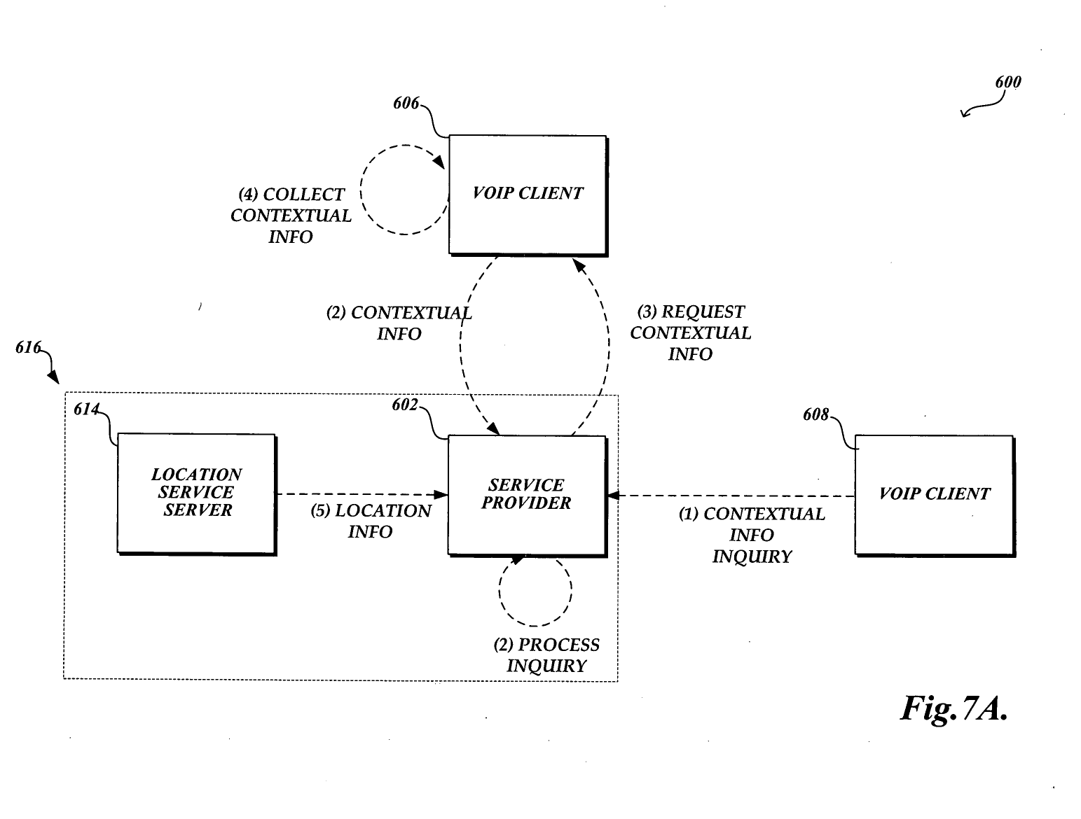

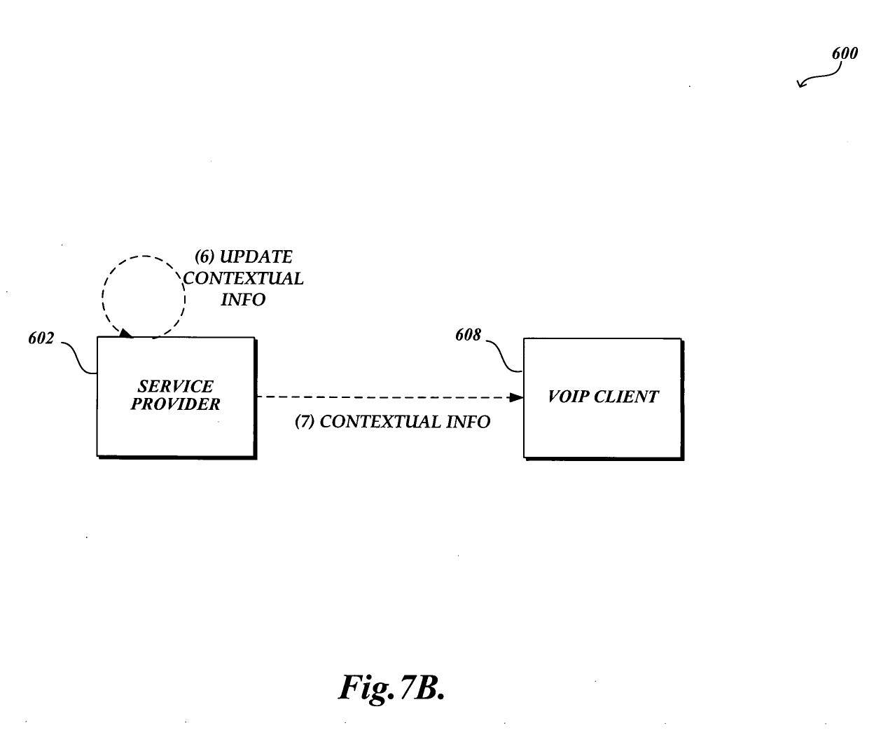

FIGS. 7A and 7B are block diagrams 700 illustrating the collection, and exchange of location information among VoIP entities in response to an inquiry for such location information in accordance with an embodiment of the present invention. In one embodiment, the VoIP entities may include VoIP clients, VoIP service providers for the clients, third party service providers (e.g., location service provider) and the like.

With reference to FIG. 7A, in one embodiment, VoIP Client 608 may send an inquiry for certain contextual information relating to VoIP Client 606. While this example utilizes one VoIP service provider and two VoIP clients, any number and combination of VoIP clients and/or service providers may be used with embodiments of the present invention. The inquiry may be seeking location information of VoIP Client 606. A service provider 602 may have obtained contextual information including location information from VoIP Client 606. As will be described in greater detail below, it is contemplated that structured hierarchies are utilized to carry contextual information (contextual data packets) between several VoIP entities in this illustrative embodiment.

For discussion purposes, assume that VoIP Client 606 and VoIP Client 608 have service provider 602 for the VoIP service provider. A location service server 614 is available for providing particular types of location information to service provider 602. As will be discussed in greater detail below, location information may include various types of information relating to client defined location, device defined location, geographic location, virtual/logical location and the like. An example of the location service servers 602 may be a Global Positioning System (GPS) service server, a User location service server (e.g., Internet locator server, a conferencing directory server on a network, etc.), and the like. The Internet location server may be used to identify individual users via current IP address. In one embodiment, VoIP Client 608 may send an inquiry for particular contextual information (e.g., geographic location information of a device) relating to VoIP Client 606. The service provider 602 processes the inquiry to identify what contextual information will be collected and which appropriate source will be contacted or queried to obtain the identified contextual information.

If the appropriate source is VoIP Client 606, the service provider 602 requests the identified contextual information to VoIP Client 606. Upon receipt of the request, VoIP Client 606 collects the requested contextual information and identifies structured hierarchies which will be used to carry the collected contextual information. The collected contextual information is transmitted from VoIP Client 606 to Provider 1 602 utilizing the identified structured hierarchies. If the appropriate source is a location service server 614, the service provider 602 obtains the information from the location service provider. In one embodiment, a service provider 616 for VoIP client 606 and VoIP client 608 may include a service provider (server) 602 and location service server 614. In this embodiment, the service provider 616 provides location information to its clients.

Alternatively, upon receipt of the inquiry, a service provider 602 obtains and/or collects any readily available location information related to VoIP Client 606 from various sources, for example, an individual user's geographic location, a device's geographic location, a device's logical location in a network, an individual user's location within virtual space, and the like. The service provider 602 may process the received location information, store desired parts of the location information and transmit subsets of the received information based on the inquiry. The stored information may be used in a future. As discussed above, the service provider 602 may further identify and obtain additional contextual information relating to the inquiry and update the current contextual information (e.g., previously obtained location information) accordingly. Further, the service provider 602 may identify part of the current contextual information to be removed, added and/or modified before transmitting the contextual information and then update the received contextual information accordingly. In one embodiment, the information regarding the identified structured hierarchies is also transmitted to the service provider 602, or directly to VoIP Client 606. The information regarding the identified structured hierarchies may include the information about which structured hierarchies are used to carry the contextual information, how to identify the structured hierarchies, and the like.

In an illustrative embodiment, by adding or deleting part of the contextual information, the service provider 602 may generate tailored contextual information suitable for responding to the inquiry from VoIP Client 608. For example, the service provider 602 may generate contextual information including a particular type of location information and other contextual information relating to the particular type of location information. The service provider 602 may transmit the tailored contextual information to VoIP Client 608. Alternatively, the service provider 602 may transmit the tailored contextual information (e.g., location information), or the obtained contextual information to a third party SP which will eventually forward the received contextual information to VoIP Client 608. The third party SP may collect more contextual information, if necessary, and update the received contextual information by adding, deleting and/or modifying information.

In one embodiment, the structured hierarchies may be defined by Extensible Markup Language (XML). However, it is to be appreciated that the structured hierarchies can be defined by any language suitable for implementing and maintaining extensible structured hierarchies. Generally described, XML is well known for a cross-platform, software and hardware independent tool for transmitting information. Further, XML maintains its data as a hierarchically-structured tree of nodes, each node comprising a tag that may contain descriptive attributes. Typically, XML namespace is provided to give the namespace a unique name. In some instances, the namespace may be used as a pointer to a centralized location containing default information about the namespace.

In accordance with an illustrative embodiment, while the communication channel is being established, VoIP Client 606 may identify a XML namespace for contextual information. For example, the XML namespace attribute may be placed in the start tag of a sending element. It is to be understood that XML namespaces, attributes, and classes illustrated herein are provided merely as an example of structured hierarchies used in conjunction with various embodiments of the present invention. After VoIP Client 608 receives the XML namespace information, the VoIP Client 606 transmits a set of contextual data packets defined in accordance with the identified XML namespace to VoIP Client 608. When a namespace is defined in the start tag of an element, all child elements with the same prefix are associated with the same namespace. As such, VoIP Client 608 and VoIP Client 606 can transmit contextual information without including prefixes in all the child elements, thereby reducing the amount of data packets transmitted for the contextual information.

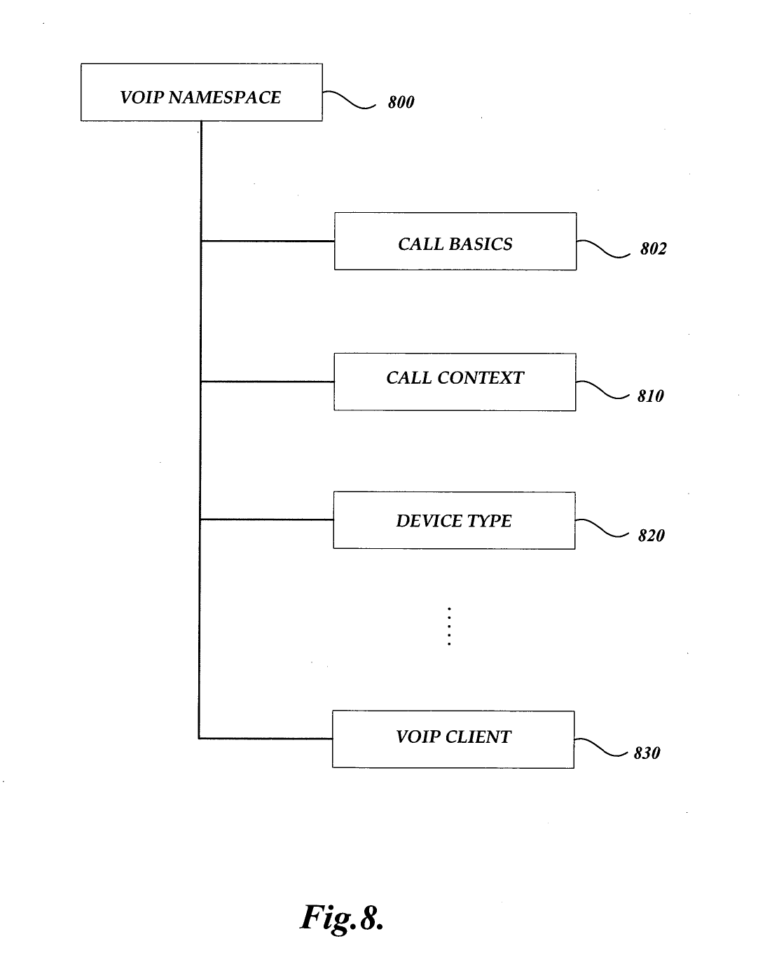

With reference to FIGS. 8-12B, block diagrams illustrative of various classes and attributes of structured hierarchies corresponding to VoIP contextual information are shown. The VoIP contextual information exchanged between various VoIP entities (e.g., clients, service providers, etc.) may correspond to a VoIP namespace 800. In one embodiment, the VoIP namespace 800 is represented as a hierarchically structured tree of nodes, each node corresponding to a subclass which corresponds to a subset of VoIP contextual information. For example, a VoIP Namespace 800 may be defined as a hierarchically structured tree comprising a Call Basics Class 802, a Call Contexts Class 810, a Device Type Class 820, a VoIP Client Class 830 and the like.

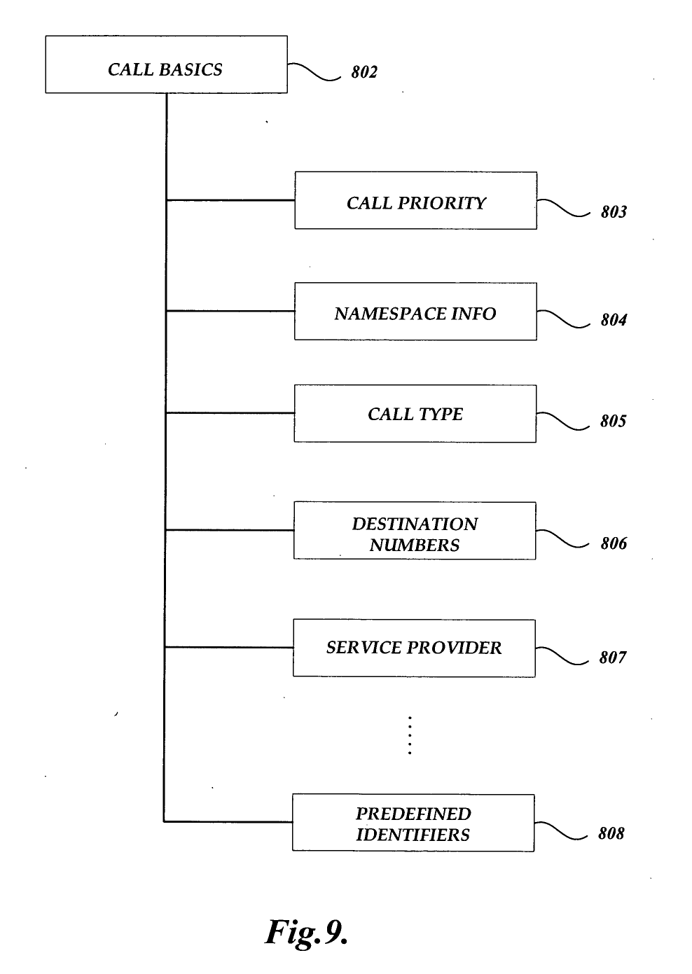

With reference to FIG. 9, a block diagram of a Call Basics Class 802 is shown. In an illustrative embodiment, Call Basics Class 802 may correspond to a subset of VoIP contextual information relating to a conversation channel connection (e.g., a PSTN call connection, a VoIP call connection, and the like). The subset of the VoIP contextual information relating to a conversation channel connection may include originating numbers (e.g., a caller's client ID number), destination numbers (e.g., callees' client ID numbers or telephone numbers), call connection time, VoIP service provider related information, and/or ISP related information such as IP address, MAC address, namespace information, and the like. Additionally, the contextual information relating to a conversation channel connection may include call priority information (which defines the priority levels of the destination numbers), call type information, and the like. The call type information may indicate whether the conversation channel is established for an emergency communication, a broadcasting communication, a computer to computer communication, a computer to POTS device communication, and so forth. In one embodiment, the contextual information relating to a conversation channel connection may include predefined identifiers which represent emotions, sounds (e.g., “ah,” “oops,” “wow,” etc.) and facial expressions in graphical symbols. In one embodiment, a Call Basics Class 802 may be defined as a sub-tree structure of a VoIP Namespace 800, which includes nodes such as call priority 803, namespace information 804, call type 805, destination numbers 806, service provider 807, predefined identifiers 808, and the like.

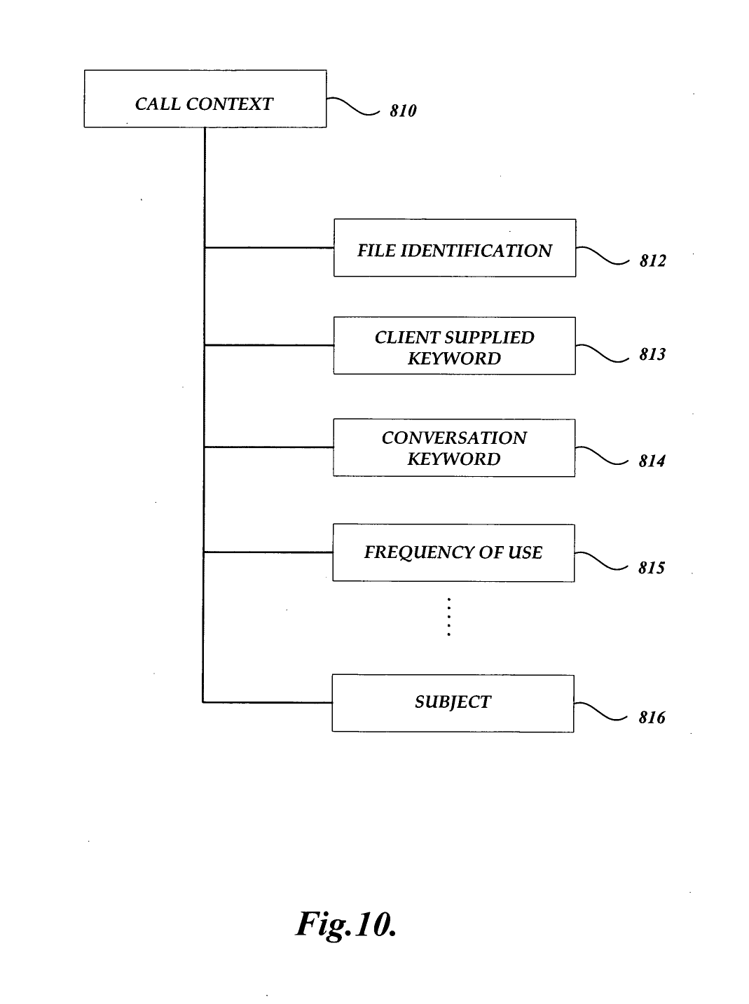

With reference to FIG. 10, a block diagram of a Call Contexts Class 810 is shown. In one embodiment, a subset of VoIP contextual information relating to conversation context may correspond to the Call Contexts Class 810. The contextual information relating to conversation context may include information such as client supplied keywords, identified keywords from document file data, identified keywords from a conversation data packet (e.g., conversation keywords), file names for documents and/or multimedia files exchanged as part of the conversation, game related information (such as a game type, virtual proximity in a certain game), frequency of use (including frequency and duration of calls relating to a certain file, a certain subject, and a certain client), and file identification (such as a case number, a matter number, and the like relating to a conversation), among many others. In accordance with an illustrative embodiment, a Call Contexts Class 810 may be defined as a sub-tree structure of a VoIP Namespace 800, which includes nodes corresponding to file identification 812, client supplied keyword 813, conversation keyword 814, frequency of use 815, subject of the conversation 816, and the like.

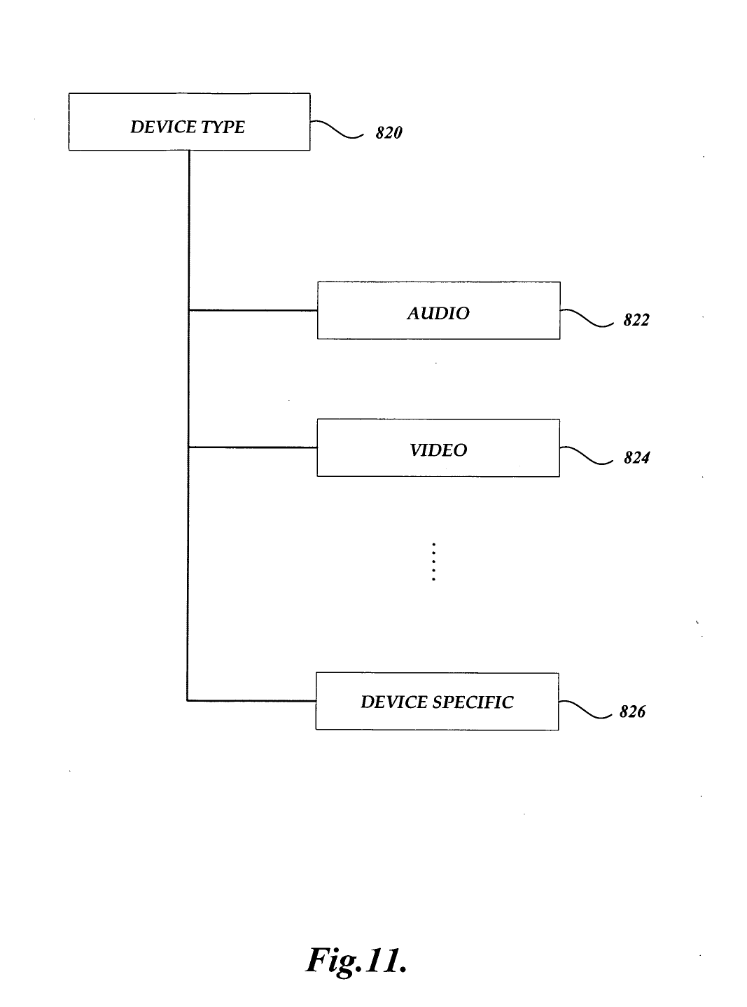

With reference to FIG. 11, a block diagram of a Device Type Class 820 is depicted. In one embodiment, a Device Type Class 820 may correspond to a subset of VoIP contextual information relating to a VoIP client device used for the conversation channel connection. The subset of the VoIP contextual information relating to the VoIP client device may include audio related information which may be needed to process audio data generated by the VoIP client device. The audio related information may include information related to the device's audio functionality and capability, such as sampling rate, machine type, output/input type, microphone, Digital Signal Processing (DSP) card information, and the like. The subset of the VoIP contextual information relating to the VoIP client device may include video related information which may be needed to process video data generated by the VoIP client device. The video related information may include resolution, refresh, type and size of the video data, graphic card information, and the like. The contextual information relating to VoIP client devices may further include other device specific information such as type of the computer system, processor information, network bandwidth, wireless/wired connection, portability of the computer system, processing settings of the computer system, and the like. In an illustrative embodiment, a Device Type Class 820 may be defined as a sub-tree structure of a VoIP Namespace 800, which includes nodes corresponding to Audio 822, Video 824, Device Specific 826 and the like.

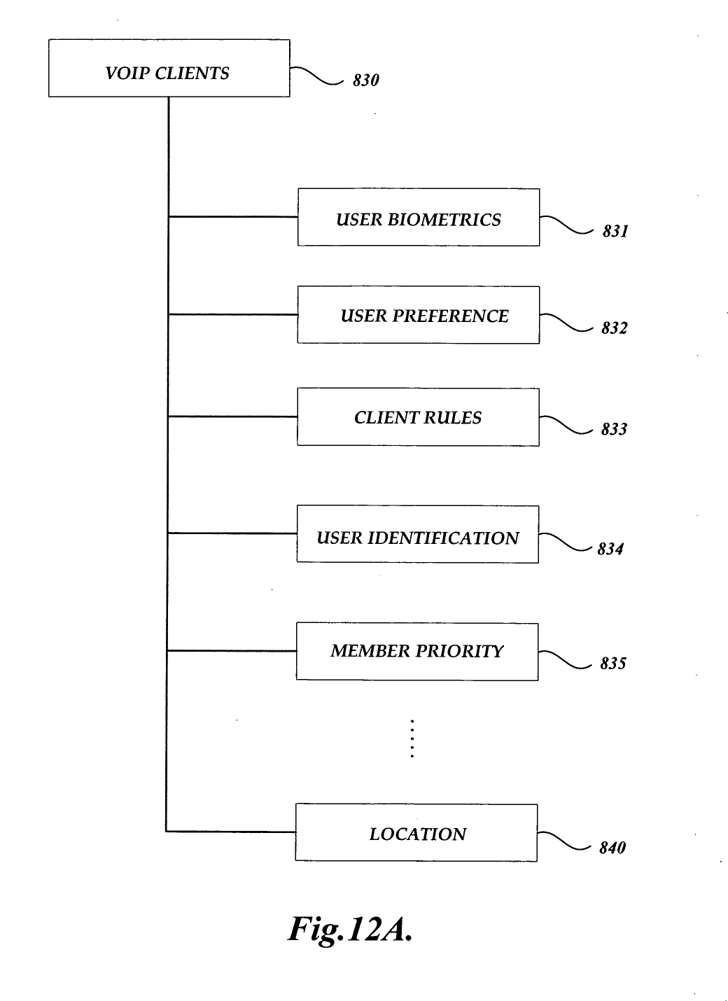

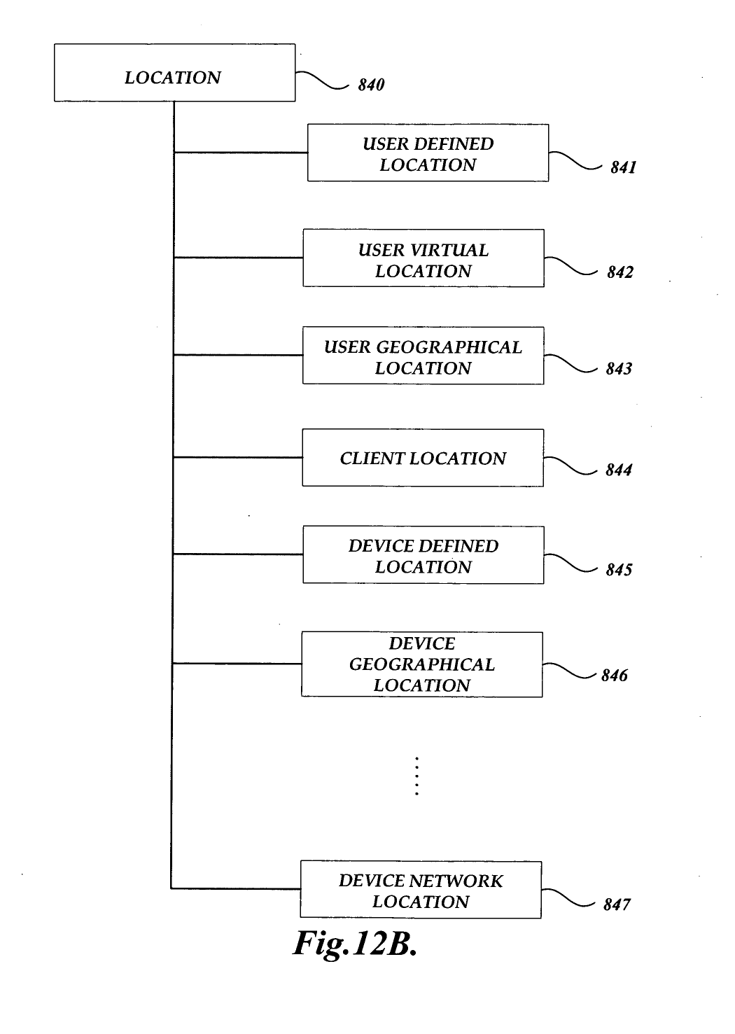

FIG. 12A depicts a block diagram of a VoIP Client Class 830. In accordance with an illustrative embodiment, a VoIP Client Class 830 may correspond to a subset of contextual information relating to VoIP clients. In one embodiment, the subset of the VoIP contextual information relating to the VoIP client may include voice profile information (e.g., a collection of information specifying the tonal and phonetic characteristics of an individual user), digital signature information, and biometric information. The biometric information can include user identification information (e.g., fingerprint) related to biometric authentication, user stress level, user mood, etc. The subset of the VoIP contextual information relating to the VoIP client may include assigned phone number, user contact information (such as name, address, company, and the like), rules defined by the client, user preferences, digital rights management (DRM), a member rank of an individual user in an organization, priority associated with the member rank, and the like. The priority associated with the member rank may be used to assign priority to the client for a conference call. As will be described in greater detail below, the subset of the VoIP contextual information relating to the VoIP client may include location information. In one embodiment, a VoIP Client Class 830 may be defined as a sub-tree structure of a VoIP Namespace 800, which includes nodes corresponding to user biometrics 831, user preference 832, client rules 833, user identification 834, member priority 835, location 840, and the like.

Referring to FIG. 12B, a block diagram of Location Subclass 840 is depicted. In one embodiment, a Location Subclass 840 may correspond to a subset of VoIP contextual information relating to location information of a VoIP client, individual user, and/or a device used for the conversation channel connection. As mentioned above, the service provider may have prior knowledge about where a certain type of location information can be obtained or queried. The subset of the VoIP contextual information relating to the location information may include information relating to a client defined location, a GPS/triangulation location (a geographic location of a particular user, a device, or a client account), a logical/virtual location of an individual user, a client defined location, a device defined location, etc. The geographic location information can be obtained from a GPS server and the like. Further, the location information may include information relating to a device network address and a service provider defined location (e.g., VoIP service provider may define a location of a client). The device network address can be an IP address of a computer, a logical location defining how logically close to a particular third party server or a service provider the device is located, and the like. In an illustrative embodiment, a Location Subclass 820 may be defined as a sub-tree structure of a VoIP Client 830, which includes nodes corresponding to User Defined Location 841, User Virtual Location 842, User Geographical Location 843, Client Location 844, Device Defined Location 845, Device Geographical Location 846, Device Network Location 847, and the like.

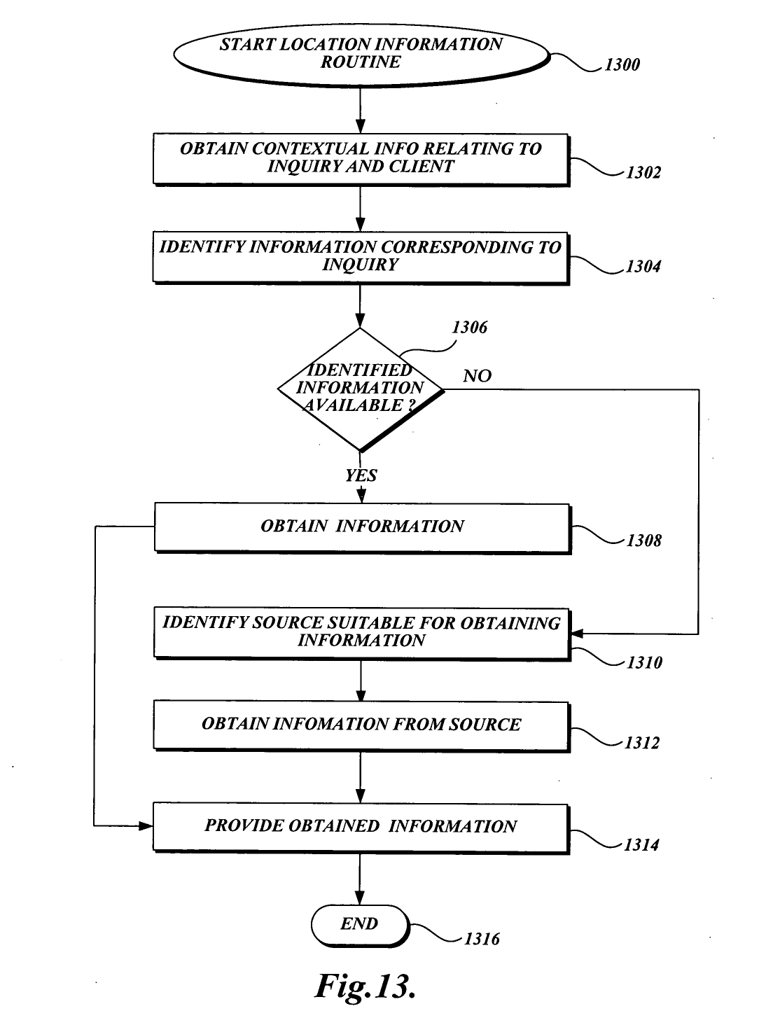

FIG. 13 is a flowchart illustrating a location information routine 1300 for providing contextual information in response to an inquiry for location information in accordance with an embodiment of the present invention. In an illustrative embodiment, a device of a caller (a calling VoIP client) may have requested its associated service provider to initiate a communication channel connection with a callee (a called VoIP client). For the purpose of discussion, assume that the caller transmits an inquiry for location information of the callee to its service provider during a connection set-up phase. A service provider of the callee may have authority to collect and provide location information of the callee. However, it is contemplated that an inquiry for particular information other than location information can be exchanged at any time, including before establishing a communication channel (e.g., during a connection set-up phase), during a conversation, or after terminating a communication channel. Further, upon receipt of an inquiry, the contextual information corresponding to the inquiry can be exchanged among the various VoIP entities. It is also contemplated that any authorized VoIP entity in the IP environment 100 can receive an inquiry and provide the contextual information in response to the inquiry.

Beginning at block 1302, the service provider obtains the caller's contextual information, including an inquiry for location information of the callee. As described above, based on the content of the contextual information, at least one structured hierarchy may be identified from predefined structured hierarchies, such as XML namespace and the like. The service provider may obtain the identified structured hierarchies from the caller. At block 1304, the service provider identifies information corresponding to the inquiry. For example, the caller requests location information of a device of the callee which is currently communicating in a conference call. The service may identify location information relating to a device's logical location (e.g., an IP address). At decision block 1306, a determination is made as to whether the identified information is currently available. The service provider may determine whether the identified information is available from the pre-obtained contextual information relating to the callee or previously stored contextual information in local storage. If the identified information is currently available, at block 1308, the service provider may obtain the currently obtained information.

If the identified information is not currently available, appropriate sources suitable for obtaining the identified information may be identified and designated at block 1310. The appropriate sources may include any VoIP entities such as the callee, a third party service server, other service provider, and the like. The service provider may contact the appropriate source and query the identified information. In one embodiment, the service provider may send contextual information for collecting the information at the source side. In an alternative embodiment, the service provider may send contextual information corresponding to an inquiry for the identified information to the source (e.g., callee). When there are multiple sources available for the identified information, the service provider may determine the most appropriate source. The service provider may have predefined provider rules or logic to determine an appropriate source for particular information. For example, a GPS server may be one of the appropriate sources for geographic location information of a device equipped with GPS modules. If an individual user's mobile phone can provide the geographic location information of a mobile device, the device may be one of the appropriate sources. Similarly, if a VoIP client maintains geographic location information of devices, the VoIP client may be one of the appropriate sources.

In this example, the service provider may select the most appropriate one based on the contextual information obtained from the caller and the callee. The contextual information may include callee's rules, caller's rules, callee's device information, a target individual user associated with the callee and the like. At block 1312, information (e.g., location information) may be obtained from the identified source. In an alterative embodiment, when there are multiple sources available for the identified information, the service provider may obtain the identified information from the multiple sources and generate comprehensive information based on the obtained information. At block 1314, the obtained information from the service provider (1308) or the obtained information from source (1312) is provided to the second VoIP client. The routine 1300 completes at 1316.

While illustrative embodiments have been illustrated and described, it will be appreciated that various changes can be made therein without departing from the spirit and scope of the invention.

The embodiments of the invention in which an exclusive property or privilege is claimed are defined as follows:

1. A method for providing contextual information relating to an information inquiry over a communication channel between a calling client and a callee client the method comprising:
receiving an inquiry for information relating to the callee client;
obtaining the contextual information relating to the callee client;
based on the callee client's contextual information, identifying a set of information corresponding to the inquiry; and
providing the collected set of information.

2. The method of claim 1, wherein identifying the set of information includes obtaining the set of information from a third party.

3. The method of claim 1, wherein the inquiry for information is part of a conversation over the communication channel.

4. The method of claim 1, wherein the set of information corresponding to the inquiry includes location information.

5. The method of claim 4, wherein the location information includes client defined location information.

6. The method of claim 4, wherein the location information includes provider defined location information.

7. A computer-readable medium having computer-executable components for providing information in response to an inquiry over a VoIP communication channel between a first client and a second client comprising:
an information managing component for receiving an inquiry for information;
an information processing component for processing the first client's contextual information and identifying a source for obtaining the information; and
wherein the information managing component obtains information corresponding to the inquiry from the source and provides the obtained information to the second client.

8. The computer-readable medium of claim 7, wherein the information processing component identifies a plurality of sources and selects the most appropriate source based on the contextual information.

9. The computer-readable medium of claim 7, wherein the inquiry for information is received from the second client.

10. The computer-readable medium of claim 7, wherein the information managing component transmits predetermined default information if the information processing component cannot identify any source.

11. The computer-readable medium of claim 7, wherein the information processing component updates the contextual information by adding the obtained information; and wherein the information managing component transmits the updated contextual information.

12. A method for providing contextual information relating to a location over a communication channel between a first client and a second client, the method comprising:
receiving an inquiry for location information of the first client;
upon receipt of the inquiry, obtaining a set of contextual information relating to the first client;
determining whether the location information is available from the set of obtained contextual information; and
if the location information is available, providing the location information to the second client.

13. The method of claim 12, wherein the inquiry for information is received as part of contextual information received from the second client.

14. The method of claim 13, wherein the contextual information is related to a conversation over a VoIP communication channel between the first client and the second client.

15. The method of claim 13 further comprising:
identifying a type of the location information based on the contextual information received from the second client.

16. The method of claim 15, wherein the type of the location information includes a geographic location of the first client.

17. The method of claim 15, wherein the type of the location information includes a network location of a client device of the first client.

18. The method of claim 12 further comprising:
if the location information is not available, determining at least one source for obtaining the location information based on the set of obtained contextual information and obtaining the location information from the at least one source.

19. The method of claim 18, wherein the at least one source of the location information includes a Global Positioning System server.

20. The method of claim 18, wherein the at least one source of the location information includes a location service server.
